(19) United States
(12) Patent Application Publication
(10) Pub. No.: US 2022/0105365 A1
(43) Pub. Date: Apr. 7, 2022

(54) INDIVIDUAL SYSTEM FOR AIR FILTRATION

(71) Applicant: Kirill Kulakovskij, Karlovy Vary (CZ)

(72) Inventor: Kirill Kulakovskij, Karlovy Vary (CZ)

(21) Appl. No.: 17/063,781

(22) Filed: Oct. 6, 2020

(51) Int. Cl. A62B 7/10; B01D 46/46; B01D 46/44; A62B 18/02; A62B 23/02; A62B 18/00; A62B 18/08

(52) U.S. Cl. CPC A62B 7/10; B01D 46/46; B01D 46/446; B01D 2279/40; A62B 23/02; A62B 18/006; A62B 18/084; A62B 18/02

(57) ABSTRACT

An air filtration system (1) for cleansing an air flow containing suspended particles, has a protective mask (2) for wearing on a user's face with a seal (3) positioned at least partly along its edges, at least one first flow channel (6) with a first inlet and a first exit aperture (11,21) and a first air filter (16), and at least one second flow channel (7) with a second inlet and a second exit aperture (12,22) and a second air filter (17). The filtration system (1) has a blower (10), which is positioned exclusively in the first flow channel (6), for creating an air flow in the first flow channel (6), a control unit (18) for controlling the operation of the blower (10), an electrical supply unit (19), and a discharge unit (5) for discharging excess air pressure from under the mask (2) during the use thereof. The second exit aperture (22) of the second flow channel (7) is positioned in direct proximity to the first exit aperture (21) of the first flow channel (6). The first and second flow channels (6,7), the control unit (18) and the electrical supply unit (19) are positioned in a single casing (4), which is mounted in the upper part of the protective mask (2) and is the only element securing the mask (2) on the user's head.

### BACKGROUND OF THE INVENTION

The present invention relates to an air filtration system with controllable air input for the cleansing of an air flow containing suspended particles. In particular, the claimed system is usable for personal cleansing of an air flow from suspended particles contained therein, such as dust, soot, pollen, drops of water and oils, and other solid particles and liquids.

Personal systems cleansing an air flow from suspended particles contained therein are known. As one example of these, the publication WO 2020/120930 A1 may be cited, which in external appearance resembles headphones, in each one of which there is located a filter and a fan drawing in air from outside, which in turn is cleansed with air filters and passed into the region of a user's nose and mouth for breathing. A disadvantage of this system is the possibility of admixture into the inhaled air of contaminants from the surrounding air that reaches the user for breathing, because of the non-airtight fit of the user's mask, only partially covering the user's face. Moreover, the positioning of the fans directly on the user's ears creates acoustic and mechanical discomfort during the operation of these fans. In another publication, KR 20180092363 A, a mask on which a fan with a filter is positioned is proposed, which covers the nose and the mouth part of a user's face. Due to the weight of the unit consisting of the fan with the filter, this design renders the mask heavy and favors its slipping downwards under the action of the force of gravitation. This necessitates reinforced securing of the mask to the user's head, as a result of which the wearing of such a mask is uncomfortable. Moreover, the mask proposed in this publication does not cover the user's eyes, as a result of which suspended particles contained in the air can fall unimpeded into the user's eyes, causing discomfort or leading to eye diseases.

The proposed invention allows the aforesaid disadvantages to be avoided, comfortably positioning a filtration system on a user's head, thus decreasing the noise level from the air blower perceived by the user and protecting not only the nose and mouth parts of the user's face from suspended particles contained in the surrounding atmosphere, but also his eyes, while enabling the user to wear glasses if necessary.

### SUMMARY OF THE INVENTION

The purpose of the present invention is to create an autonomous personal air filtration system, allowing it to be positioned comfortably for wearing on a user's head without supplementary securing devices, and also allowing the level of air blower noise perceived by the user to be decreased, at the same time protecting the user's whole face.

This task is accomplished in accordance with the air filtration system as disclosed herein. The most preferable embodiments of the invention are also presented herein and in the dependent claims.

The claimed air filtration system has a protective mask for wearing on the user's face with a seal positioned at least in part along its edges, thus creating an enclosed space between the inside surface of the mask and the user's face and, correspondingly, his head part. The seal positioned along the edge part of the mask also in part fulfills the function of retaining the mask on the user's head, preventing any change in its position after fitting. In the upper part of the protective breathing mask there is positioned a casing surrounding the parietal part of the user's head with the part of it adjacent to the user's head. This enables the mask to be retained on the head essentially due to the fitting of the casing to the parietal part of the user's head, which casing is the only element securing the mask on the user's head. The forced supply of air into the space between the mask and the user's face is effected by means of at least one first flow channel and at least one second flow channel, which are positioned in the casing, wherein exclusively in the first flow channel there is mounted a blower for creating therein a flow of air, passed through a first air filter to a first exit aperture of the first flow channel, after which the air enters the space bounded by the inside surface of the mask and the user's face. The forced air flow, passing through the first flow channel, due to the positioning of a second exit aperture of the second flow channel in direct proximity to the first exit aperture of the first flow channel, entrains an additional flow of air through the second flow channel, in which filters are also mounted. In this manner, the main forced air flow, passing through the first channel, draws air from the second additional channel into the space situated under the mask, thus allowing the quantity of air forced into the space between the mask and the user's face to be increased without increasing the power of the fan. In turn, this leads to a decrease in the acoustic and vibrational stress induced by the blower, in comparison to the prior art, where there are only one or a few channels, in each of which a fan is mounted.

Due to the air passed into the space between the mask and the user's face, an excess pressure is created there, the maximum value whereof is controlled by a discharge unit for discharging excess air pressure from under the mask during the use thereof. In the single casing there are also mounted control units for controlling the operation of the fan, and an electrical supply unit. With manufacture of the mask from light plexiglass, obviously the main mass of the filtration system is centered in the casing, which yields one more advantage for reducing damage to the outside surface of the mask, namely that on removal of the filtration system and placing thereof on a flat surface, it automatically positions itself according to the “roly-poly toy” principle such that the surface of the casing is in contact with the surface on which the mask was placed.

According to a main embodiment of the invention, the second exit aperture is positioned at a distance from the first exit aperture allowing a jet of air streaming out from the first exit aperture to entrain after itself air from the second exit aperture according to the ejection principle.

Preferably the first and second exit apertures are positioned at a distance from each other less than one quarter of the minimum cross-sectional size of the first exit aperture, which can have various shapes, for example the shape of a circle, oval, square, rhombus or triangle.

According to one of the embodiments of the claimed system, the second exit aperture is positioned adjacent to the first exit aperture. In this case, the ejection effect is maximal.

According to yet another embodiment of the system, the first and second inlet apertures are positioned apart from each other at a distance exceeding one quarter of the minimum cross-sectional size of the first inlet aperture. Here the first inlet aperture can have various shapes, for example a circular, oval, square, rhomboidal or triangular shape. The second inlet aperture can have the shape of a ring surrounding the first inlet aperture, the spacing of the first inlet aperture from the second inlet aperture being determined by the minimum distance between them. There can also be several second apertures and they can have various shapes and be positioned either in one line with the first inlet aperture, or around it.

According to one of the embodiments of the claimed system, the first flow channel has a forcing chamber, converging in the direction from the first inlet aperture to the second inlet aperture. This allows the flow emerging through the first exit aperture to be accelerated, and correspondingly allows the ejection effect to be strengthened. In this case, the forcing chamber can be positioned in any part of the first flow channel.

According to a further embodiment of the claimed system, the discharge unit for discharging excess air pressure from under the mask during the use thereof is implemented either in the form of a partly air-permeable seal, positioned at least partly along the edges of the mask, or in the form of a discharge valve, opening at a designated elevated level of pressure between the mask and the user's face. As the partly air-permeable seal, for example, partly air-permeable foam rubber may be used. As the discharge valve, either textile valves, integrated into the seal, or mechanical valves of known design, opening for discharge of air from under the mask at a designated elevated level of pressure between the mask and the user's face and closing on a decrease in the pressure, may be used. These valves can be positioned either on the surface of the mask, on its peripheral regions, or in the casing for discharge of air outwards. Alternatively, these valves can be positioned in a second channel or, correspondingly, in second channels.

One of the implementations of the filtration system envisages a pressure sensor, communicating with the space bounded by the inside surface of the mask and the face and, correspondingly, the surface of the user's head. In this case, the control unit is implemented with the possibility of controlling the rhythm and volume of the air passed into the mask by the blower depending on the pressure measured by this pressure sensor, thereby allowing the operation of the blower to be controlled on the basis of the pressure drop in the mask when the user inhales and the pressure rise when the user exhales.

A further embodiment of the filtration system envisages implementation of the control unit with the possibility of maintaining the pressure between the mask and the user's face at 0.01-20% higher than atmospheric pressure, at least during exhalation. Also additionally envisaged is the possibility of maintaining the pressure between the mask and the user's face at this same level during inhalation too. This allows the user to be continuously supplied with fresh cleansed air, which has exclusively or mostly passed through the first and second inlet apertures with filters.

According to one of the embodiments of the filtration system, the protective mask is implemented in the form of a full-face visor, transparent or covered with a photochromic layer, the edges whereof essentially replicate the contours of the user's face adjacent to it. Most preferably, the mask is implemented so as to be flexible, due to which adaptation of the shape of the mask to various shapes of a user's head is achieved, such that people of larger head size and smaller head size can use a mask of one size. Most preferably, the mask is implemented in a shape passing under the user's chin, and in this case the soft and bulky seal in the lower part of the mask ensures its tight abutment under the user's chin and blocks displacement of the lower part of the mask forwards or backwards. Either the upper part of the mask or the whole mask in its entirety can be covered with a photochromic layer, thus adapting the degree of darkening of the mask depending on the intensity of illumination from outside.

According to yet another embodiment of the filtration system, the overall center of gravity of the casing with the aforesaid elements of the mask contained in it is implemented so as to fall within the parietal region of the user's head, which allows the mask with the casing to be reliably retained on the user's head without supplementary retaining appliances.

Preferably the mask is implemented so as to be sufficiently wide in the region of the user's eyes, enabling a user with glasses to use this mask. In this case, the temples of the glasses are closely enclosed by a seal also positioned in the side edge part of the mask, without creating gaps around the temples of the glasses that would adversely affect the airtightness of the mask.

Preferably the first and second air filters are implemented with the possibility of replacing them after prolonged use thereof. Preferably filters of the HEPA or ULPA type are used as the air filters.

The claimed filtration system with the full-face mask and the casing positioned in its upper part also allows a navigation system to be positioned in the casing, and allows the inside surface of the breathing mask to be used as a navigation system display.

Yet another embodiment of the claimed system envisages the use of an application for a mobile device as a user control interface and/or an interface for the display of functional parameters of the filtration system. In this case, the need for positioning of button and other sensory control elements on the surface of the casing for controlling the operation of the filtration system is obviated.

### BRIEF DESCRIPTION OF THE DRAWINGS

In the drawings:

FIG. 1 shows an external view of one of the embodiments of the claimed filtration system.

FIG. 2 is a schematic representation of cross section A-A of the casing shown in FIG. 1.

FIG. 3 is a schematic representation of the filtration system in front view, showing the movement of the air flows in the filtration system and out from it.

### DETAILED DESCRIPTION

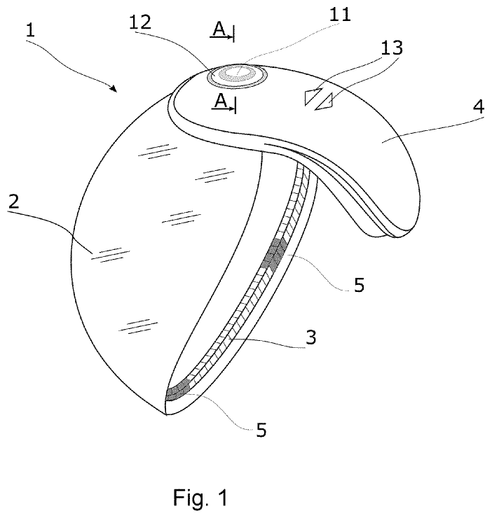

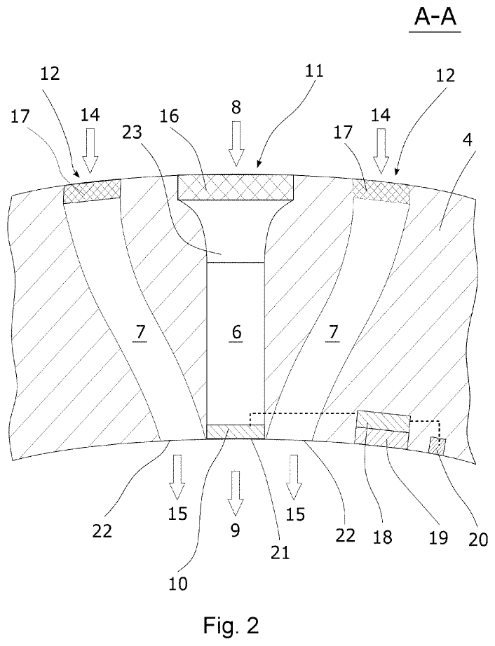

The present invention describes an autonomous personal air filtration system for cleansing an air flow containing suspended particles. FIG. 1 shows one of the embodiments of the claimed filtration system. The filtration system 1 has a full-face protective mask 2 with a casing 4 attached in its upper part. The protective mask 2 is made from flexible transparent plexiglass, along the inside edges of which mask, excluding the part of the mask to which the casing 4 is attached, there is positioned a seal 3, made of soft foam rubber and intended for sealing the space between the inside edges of the mask 2 and the face and, correspondingly, the head of the user. In the lower and side parts of the mask 2, a part of the seal 3 is implemented in the form of air-permeable foam rubber, acting as a discharge unit 5 for discharging excess air pressure from under the mask 2 during the use thereof. The seal 3 and the discharge unit 5 are implemented so as to pass into each other with no gap. The inside surface of the mask 2, the seal 3, the discharge unit 5, the inside surface of the casing 4 and the face situated under the mask and, correspondingly, the parts of the user's head under the casing form an enclosed space. In the front upper part of the casing 4, in the region in which the casing 4 adjoins the mask 2, there is positioned a circular first inlet aperture 11 and, concentrically to it, at a certain distance from it, a second inlet aperture 12. The relationship of the first and second inlet apertures 11, 12 will be shown below in the discussion of FIG. 2. The casing 4 itself is implemented with an extended, almost oval shape in a top view, wherein the part of it distant from the mask is implemented so as to be curved downwards towards the mask in such a manner that the lower surface of the casing 4 positioned on the mask side has the shape of the parietal part of the user's head. In the middle part of the casing 4 on its upper surface are positioned two buttons for controlling the operation of the blower (see FIG. 2).

FIG. 2 shows a partial section of the casing 4 along the line A-A, shown in FIG. 1. In the central part of FIG. 2 is shown a first flow channel 6, having the first inlet aperture 11 on the upper surface of the casing 4 and a first exit aperture 21 on the lower surface of the casing 4. In the first flow channel 6 of its upper part there is positioned a first air filter 16. In the lower part of the first flow channel 6 there is positioned a blower 10 for an air medium. A fan, air pump or any other device for blowing an air medium known from the prior art can be used as the blower. Alternatively, in contrast to the position of the blower 10 shown in FIG. 2, it can be positioned in any part of the first flow channel 6. The blower 10 serves to create an air flow in the first flow channel 6 in the direction from the first inlet aperture 11 to the first exit aperture 21. An air flow entering the first flow channel is indicated by the arrow 8, while an air flow exiting from the first exit aperture is indicated by the arrow 9. In the upper part of the first flow channel 6, there is a forcing chamber 23, decreasing in cross section in the direction from the first inlet aperture 11 towards the first exit aperture 21. The air passing through the first flow channel 6 is filtered by the first filter 16. In FIG. 2 to the right and left of the first flow channel 6 there is positioned a second flow channel 7, implemented concentrically around the first flow channel 6. The second flow channel 7 in cross section has an equal width along its whole length and extends from the upper surface of the casing 4, starting at the second inlet aperture 12, to the lower surface of the casing 4, ending with a second exit aperture 22. In the upper part of the second flow channel 7 there is positioned a second filter 17. In the filtration system embodiment example shown, the second inlet aperture 12 is separated from the first inlet aperture approximately by a distance equal to half the diameter of the first inlet aperture 11, while the second exit aperture 22 is positioned adjacent to the first exit aperture 21. Alternatively to this embodiment, the first and second inlet apertures 11, 12 may be positioned at a distance from each other exceeding one quarter of the minimum cross-sectional size of the first inlet aperture 11, while the first and second exit apertures 21, 22 may be positioned at a distance from each other less than one quarter of the minimum cross-sectional size of the first exit aperture 21. Such positioning of the exit apertures is determined exclusively by the essential condition of fulfilment of the principle of ejection of a jet of air streaming out from the first exit aperture, that is the necessity of entraining after itself air from the second exit aperture 22. In other words, the air flow 9 exiting from the first flow channel 6 entrains after itself air flows 15 exiting from the second flow channel 7, thus not requiring the positioning of additional blowers in the second flow channel 7.

In the lower right-hand part of FIG. 2, on the lower surface of the casing 4, there are positioned a control unit 18 for controlling the operation of the blower 10 and, connected to it, an electrical supply unit 19, and also a pressure sensor 20, communicating with the space bounded by the inside surface of the mask 2 and the face and, correspondingly, the surface of the user's head. The control unit 18 is functionally connected to the blower 10 and the pressure sensor 20, as is shown by the dotted line in FIG. 2. The pressure sensor 20 measures the pressure in said space, while the control unit 18 is implemented with the possibility of controlling the rhythm and volume of the air passed into the mask 2 by the blower 10, depending on the pressure measured by the pressure sensor 20. This allows the operation of the blower 10 to be controlled depending on the pressure measured by the pressure sensor 20. Thus when the user inhales, the pressure in the aforesaid space falls, and as a result of this the control unit 18 gives a signal to the blower 10 to increase the intensity of blowing of air in the first flow channel 6, thus maintaining the pressure between the mask and the user's face at 0.01-20% higher than the external atmospheric pressure. When the user exhales, the pressure under the mask increases, which is registered by the pressure sensor 20, and correspondingly the control unit 18 gives a command to the blower 10 to decrease the blown volume of air, or to temporarily cease the operation of the blower. Due to this, when the user exhales the pressure between the mask and the user's face is also maintained at 0.01-20% higher than atmospheric pressure. The excess pressure from under the mask when the user exhales is decreased due to the discharge of excess air pressure under the mask by the excess pressure discharge unit 5, shown in FIG. 1.

In an alternative embodiment of the filtration system, the filtration system is implemented without pressure sensor 20 (not shown), thus the intensity of operation of the blower 10 remains constant, and correspondingly this constant level of blower operation can be controlled by buttons 13 for controlling the operation of the blower, which are connected to the control unit 18 and are shown in FIG. 1. In this embodiment of the filtration system, the blower 10 operates constantly, creating in the space under the mask 2 an excess pressure, which when the user exhales is maintained at a constant level above atmospheric pressure due to the discharge of air from under the mask by the excess air pressure discharge unit 5.

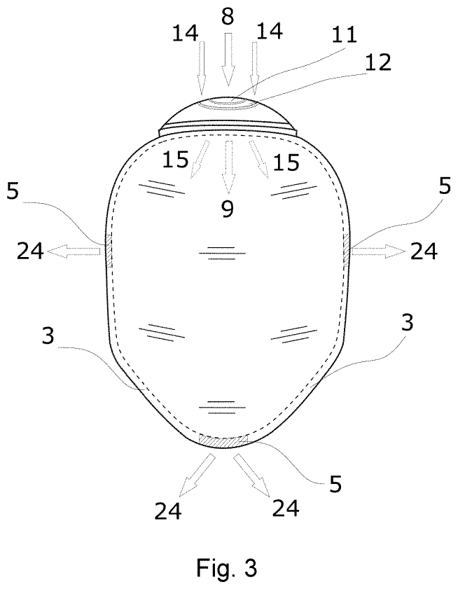

The operating principle of the filtration system is shown schematically in front view in FIG. 3. The air flow 8 entering the first flow channel, accelerated by the blower 10, exits into the space under the mask in the form of the air flow 9 exiting from the first flow channel, entraining after itself due to the ejection effect the air flows 15 exiting from the second flow channel, as a result of which air flows 14 entering the second flow channel are sucked into the second flow channel 7. Excess pressure under the mask is decreased by means of the excess air pressure discharge units 5 positioned in the lower and the side part of the mask. In alternative embodiments of the filtration system, the number and position of the excess air pressure discharge units 5 may differ from those shown in FIG. 3. The excess air pressure discharge units 5 are implemented either in the form of a partly air-permeable seal 5, positioned continuously in one line with the seal 3, or in the form of a discharge valve (not shown), opening at a designated elevated level of pressure between the mask 2 and the user's face. However, in an alternative embodiment, the discharge valves may be positioned either on the surface of the mask 2, or in the casing 4 or in the second flow channel 7.

In alternative embodiments of the filtration system, the number and position of the second flow channels 7 may be other than as shown in FIG. 2.

Most preferable is an implementation of the casing 4 with the possibility of replacement of the first and second air filters 16, 17, which are filters of the HEPA or ULPA type.

The compact positioning of all elements of the filtration system except the mask 2 in the casing 4, and also the implementation of the mask 2 as a full-face mask allow a navigation system to be incorporated into the casing 4, the display of said navigation system being the inside surface of the protective mask 2 (not shown). According to yet another embodiment of the filtration system, it has an application for a mobile device as a user control interface and/or an interface for the display of functional parameters of the filtration system, such as the level of maintenance of pressure under the mask, and others.

### REFERENCE DESIGNATIONS

1 Air filtration system
2 Protective mask
3 Seal
4 Casing
5 Excess air pressure discharge unit
6 First flow channel
7 Second flow channel
8 Air flow entering first flow channel
9 Air flow exiting from first flow channel
10 Blower
11 First inlet aperture of first flow channel
12 Second inlet aperture of second flow channel
13 Buttons for controlling blower operation
14 Air flow entering second flow channel
15 Air flow exiting from second flow channel
16 First filter
17 Second filter
18 Control unit for controlling blower operation
19 Electrical supply unit
20 Pressure sensor
21 First exit aperture of first flow channel
22 Second exit aperture of second flow channel
23 Forcing chamber of first flow channel
24 Air flows exiting from mask

1. An air filtration system (1) for cleansing an air flow containing suspended particles, having
a protective mask (2) for wearing on a user's face with a seal (3) positioned at least partly along its edges, at least one first flow channel (6), having a first inlet aperture (11) and a first exit aperture (21), and a first air filter (16) positioned in the first flow channel (6), at least one second flow channel (7), having a second inlet aperture (12) and a second exit aperture (22), and a second air filter (17) positioned in the second flow channel (7), wherein the filtration system (1) has a blower (10), which is positioned exclusively in the first flow channel (6), for creating in the first flow channel (6) an air flow from the first inlet aperture (11) to the first exit aperture (21),
a control unit (18) for controlling the operation of the blower (10),
an electrical supply unit (19),
a discharge unit (5) for discharging excess air pressure from under the mask (2) during the use thereof,
wherein the second exit aperture (22) of the second flow channel (7) is positioned in direct proximity to the first exit aperture (21) of the first flow channel (6),
wherein the first and second flow channels (6,7), the control unit (18) and the electrical supply unit (19) are positioned in a single casing (4), which is mounted in the upper part of the protective mask (2) and is the only element securing the mask (2) on the user's head.

2. The filtration system according to claim 1, wherein the second exit aperture (22) is positioned at a distance from the first exit aperture (21) allowing a jet of air streaming out from the first exit aperture (21) to entrain after itself air from the second exit aperture (22) according to the ejection principle.

3. The filtration system according to claim 1, wherein the first and second exit apertures (21,22) are positioned at a distance from each other less than one quarter of the minimum cross-sectional size of the first exit aperture (21).

4. The filtration system according to claim 1, wherein the second exit aperture (22) is positioned adjacent to the first exit aperture (21).

5. The filtration system according to claim 1, wherein the first and second inlet apertures (11,12) are positioned at a distance from each other exceeding one quarter of the minimum cross-sectional size of the first inlet aperture (11).

6. The filtration system according to claim 1, wherein a forcing chamber (23), converging in the direction from the first inlet aperture (11) to the second inlet aperture (12), is a component part of the first flow channel (6).

7. The filtration system according to claim 1, wherein the discharge unit (5) for discharging excess air pressure from under the mask (2) during the use thereof is implemented
either in the form of a partly air-permeable seal (5), positioned at least partly along the edges of the mask (2),
or in the form of a discharge valve, opening at a designated elevated level of pressure between the mask (2) and the user's face.

8. The filtration system according to claim 1, having a pressure sensor (20), communicating with the space bounded by the inside surface of the mask (2) and the face and, correspondingly, the surface of the user's head, wherein the control unit (18) is implemented with the possibility of controlling the rhythm and volume of the air passed into the mask (2) by the blower (10) depending on the pressure measured by the pressure sensor (20), allowing the operation of the blower (10) to be controlled on the basis of the pressure drop in the mask (2) when the user inhales and the pressure rise when the user exhales.

9. The filtration system according to claim 8, wherein the control unit (18) is implemented with the possibility of maintaining the pressure between the mask and the user's face at 0.01-20% higher than atmospheric pressure both when the user inhales and when the user exhales.

10. The filtration system according to claim 1, wherein the protective mask (2) is implemented in the form of a full-face visor, transparent or covered with a photochromic layer, the edges whereof essentially replicate the contours of the user's face adjacent to it.

11. The filtration system according to claim 1, having one first flow channel (6) and several second flow channels (7) positioned around it.

12. The filtration system according to claim 1, wherein the overall center of gravity of the casing (4) and the mask (2) is implemented so as to fall within the parietal region of the user's head.

13. The filtration system according to claim 1, implemented with the possibility of replacing the first and second air filters (16,17).

14. The filtration system according to claim 1, wherein the air filters (16,17) are filters of the HEPA or ULPA type.

15. The filtration system according to claim 1, having incorporated into the casing (4) a navigation system, the display whereof is the inside surface of the protective mask (2).

16. The filtration system according to claim 1, having an application for a mobile device as a user control interface and/or an interface for the display of functional parameters of the filtration system (1).
